(19) United States
(12) Patent Application Publication
(10) Pub. No.: US 2026/0187448 A1
(43) Pub. Date: Jul. 2, 2026

(54) METHODS AND SYSTEMS FOR COMPRESSING AND FINE-TUNING MACHINE LEARNING MODEL

(71) Applicant: NAVER CORPORATION, Seongnam-si (KR)

(72) Inventors: Se Jung KWON, Seongnam-si (KR); Dongsoo LEE, Seongnam-si (KR); Jeonghoon KIM, Seongnam-si (KR); Jung Hyun LEE, Seongnam-si (KR); Jung Woo HA, Seongnam-si (KR); Nako SUNG, Seongnam-si (KR); Jin-Hwa KIM, Seongnam-si (KR); Baeseong PARK, Seongnam-si (KR); Byeoung Wook KIM, Seongnam-si (KR); Sung Dong KIM, Seongnam-si (KR); Kang-Min YOO, Seongnam-si (KR)

(73) Assignee: NAVER CORPORATION, Seongnam-si (KR)

(21) Appl. No.: 19/542,770

(22) Filed: Feb. 18, 2026

Related U.S. Application Data
(63) Continuation of application No. PCT/KR2023/014706, filed on Sep. 25, 2023.

(30) Foreign Application Priority Data
Aug. 18, 2023 (KR) 10-2023-0108020

(51) Int. Cl. G06N 3/08; G06N 3/0495

(52) U.S. Cl. CPC G06N 3/08; G06N 3/0495

(57) ABSTRACT

The present disclosure relates to a method for compressing and fine-tuning a machine learning model performed by at least one processor. The method includes generating a quantized model by quantizing at least some of parameters of a trained machine learning model, and fine-tuning the quantized model for a target task by fixing a first subset of parameters of the quantized model, and updating only a second subset of the parameters of the quantized model using training data associated with the target task, the second subset of the parameters of the quantized model not including any parameter among the first subset of parameters of the quantized model.

This application is a continuation of, and claims the benefit of priority under 35 U.S.C. 365 (c) from International Application No. PCT/KR2023/014706, filed on Sep. 25, 2023 in the World Intellectual Property Organization (WIPO), which designates the United States of America and claims priority benefit of Korean Patent Application No. 10-2023-0108020, filed on Aug. 18, 2023, the disclosures of each of which are incorporated herein by reference.

### TECHNICAL FIELD

The present disclosure relates to a method and a system for compressing and fine-tuning a machine learning model and, more particularly, to a method and a system for compressing and fine-tuning a machine learning model to simultaneously (or contemporaneously) achieve quantization and parameter-efficient fine-tuning of the machine learning model, thereby improving performance for a target task.

### BACKGROUND

With the recent advance of artificial intelligence technologies, among others, language models are being actively utilized and commercialized. A language model serves to understand meanings from a vast amount of text expressed by humans, to extract and classify information included in the text, and to further generate text.

In recent years, language models pretrained (or trained) through self-supervised learning have attracted significant attention due to their excellent performance, and are being applied to various fields, including natural language processing, automatic speech recognition, and computer vision. However, in order to utilize a pretrained (or trained) language model for a specific task, a process of fine-tuning the pretrained (or trained) language model is generally performed to render the pretrained (or trained) language model suitable for the specific task, so as to improve performance. Since language models pretrained (or trained) through self-supervised learning typically include a large number of parameters, research has been conducted on Parameter-Efficient Fine-Tuning (PEFT) methods.

### SUMMARY

In order to address the challenges described above, the present disclosure provides a method, a non-transitory computer-readable recording medium in which instructions are recorded, and an apparatus (e.g., a system).

The present disclosure may be implemented in various forms, including a method, an apparatus (e.g., a system), or a non-transitory computer-readable recording medium in which instructions are recorded.

According to some example embodiments of the present disclosure, a method for compressing and fine-tuning a machine learning model, performed by at least one processor, includes generating a quantized model by quantizing at least some of parameters of a trained machine learning model, and fine-tuning the quantized model for a target task by fixing a first subset of parameters of the quantized model, and updating only a second subset of the parameters of the quantized model using training data associated with the target task, the second subset of the parameters of the quantized model not including any parameter among the first subset of parameters of the quantized model.

A non-transitory computer-readable recording medium recording instructions that, when executed by a computer, cause the computer to perform the method according to some example embodiments of the present disclosure, is provided.

According to some example embodiments of the present disclosure, an information processing system includes a memory including at least one computer-readable program, and at least one processor connected to the memory and configured to execute the at least one computer-readable program to cause the information processing system to generate a quantized model by quantizing at least some of parameters of a trained machine learning model, and fine-tune the quantized model for a target task by fixing a first subset of the parameters of the quantized model, and updating only a second subset of the parameters of the quantized model using training data associated with the target task, the second subset of the parameters of the quantized model not including any parameter among the first subset of parameters of the quantized model.

According to some example embodiments of the present disclosure, a model fine-tuned after quantization may exhibit excellent performance for a target task, despite being of a smaller model size. Accordingly, accurate inference may be performed at a higher inference speed while using a smaller memory space.

In addition, according to some example embodiments of the present disclosure, through parameter-efficient fine-tuning, an optimizer state size may be reduced, and resources required (or otherwise, used) for managing checkpoint for respective target tasks and switching between target tasks may be saved.

The effects of the present disclosure are not limited to the effects described above, and other effects not explicitly mentioned herein will be clearly understood by those skilled in the art to which the present disclosure pertains (“persons skilled in the art”) from the claims.

### BRIEF DESCRIPTION OF THE DRAWINGS

FIG. 1 illustrates an overview of a method for compressing and fine-tuning a machine learning model according to some example embodiments of the present disclosure.

FIG. 2 is a block diagram illustrating an internal configuration of an information processing system according to some example embodiments of the present disclosure.

FIG. 3 is a flowchart illustrating an example of a method for compressing and fine-tuning a machine learning model according to some example embodiments of the present disclosure.

FIG. 4 illustrates an example of a method for quantizing at least some of parameters of a pretrained (or trained) model according to some example embodiments of the present disclosure.

FIG. 5 illustrates an example of a structure of a quantized model according to some example embodiments of the present disclosure.

FIG. 6 illustrates an example of a method for fine-tuning a quantized model according to some example embodiments of the present disclosure.

FIG. 7 illustrates an example of a method for quantizing at least some of parameters of a pretrained (or trained) model according to some example embodiments of the present disclosure.

FIG. 8 illustrates an example of a method for fine-tuning a quantized model according to some example embodiments of the present disclosure.

FIG. 9 illustrates an example of comparison and evaluation of model performance according to some example embodiments of the present disclosure.

FIG. 10 illustrates an example of comparison and evaluation of a model size, an optimizer size, and perplexity according to some example embodiments of the present disclosure.

### DETAILED DESCRIPTION

Hereinafter, some example embodiments of the present disclosure will be described in detail with reference to the accompanying drawings. In the following description, detailed descriptions of well-known functions or configurations that may unnecessarily obscure the subject matter of the present disclosure will be omitted.

In the accompanying drawings, the same (or similar) or corresponding components are denoted by the same (or similar) reference numerals. In addition, in the description of the examples below, descriptions of the same (or similar) or corresponding components may be omitted to avoid (or reduce) redundancy. However, the omission of descriptions regarding components in a given example does not indicate that such components are from every implementation of the given example.

The advantages and features of the disclosed examples and methods for achieving them will become apparent from the examples described below in conjunction with the accompanying drawings. However, the present disclosure is not limited to the examples disclosed herein and may be implemented in various different forms. The examples are provided to make the present disclosure complete and to fully convey the scope of the present disclosure to those skilled in the art.

The terms used in this specification will be briefly described, and the examples disclosed will be described in detail. The terms used in this specification are selected from currently widely used general terms in consideration of their functions in the present disclosure. However, such terms may vary depending on the intentions of those skilled in the art, judicial precedents, or the emergence of new technologies. In addition, in specific cases, terms selected (or devised) by the applicant may be used, and in such cases, the meanings thereof will be described in detail in the corresponding description of the present disclosure. Accordingly, the terms used in the present disclosure should be defined based on their meanings and the overall content of the present disclosure, rather than merely the names of the terms.

As used herein, the singular form includes the plural form unless the context clearly indicates otherwise. In addition, the plural form includes the singular form unless the context clearly indicates otherwise. Throughout the specification, when a component is described as being included, this does not mean other components are excluded, but rather to indicate that other components may be further included, unless expressly stated otherwise.

In addition, the term “module” or “unit” as used in the specification refers to a hardware component or a combination of a hardware and software components, and the “module” or “unit” performs certain functions. However, the “module” or “unit” is not limited to software or hardware. The “module” or “unit” may be configured to be stored in a non-transitory addressable storage medium or may be configured to execute on one or more processors. Therefore, for example, the “module” or “unit” may include at least one of components such as software components, object-oriented software components, class components, and task components, processes, functions, properties, procedures, subroutines, segments of program code, drivers, firmware, microcode, circuits, data, databases, data structures, tables, arrays, or variables. The components and the “modules” or “units” providing functions described herein may be combined into a smaller number of components and “modules” or “units,” or may be further divided into additional components and “modules” or “units.”

According to some example embodiments of the present disclosure, the “module” or “unit” may be implemented by processing circuitry. The term “processing circuitry” as used in the present disclosure should be interpreted broadly to refer to, for example, hardware including logic circuits; a hardware/software combination such as a processor executing software; or a combination thereof. For example, the processing circuitry more specifically may include, but is not limited to, a general-purpose processor, a Central Processing Unit (CPU), an Arithmetic Logic Unit (ALU), a Graphics Processing Unit (GPU), a microprocessor, a Digital Signal Processor (DSP), a controller, a microcontroller, a microcomputer, a state machine, an Application-Specific Integrated Circuit (ASIC), a Programmable Logic Device (PLD), a Field Programmable Gate Array (FPGA), a System-on-Chip (SOC), a programmable logic unit, or the like. The “processing circuitry” may also refer to a combination of processing devices, for example, a combination of a DSP and a microprocessor, a combination of multiple microprocessors, a combination of one or more microprocessors coupled with a DSP core, or a combination of any other such configurations.

According to some example embodiments of the present disclosure, “module” or “unit” may be implemented by a processor and memory. The “memory” should be interpreted broadly to include any electronic component capable of storing electronic information. The “memory” may also refer to various types of processor-readable media, such as a Random Access Memory (RAM), a Read-Only Memory (ROM), a Non-Volatile Random Access Memory (NVRAM), a Programmable Read-Only Memory (PROM), an Erasable Programmable Read-Only Memory (EPROM), an Electrically Erasable Programmable Read-Only Memory (EEPROM), a flash memory, a magnetic or optical data storage device, registers, and the like. If a processor is capable of reading information from a memory and/or writing information to the memory, the memory is referred to as being in an electronic communication state with the processor. A memory integrated into the processor is in an electronic communication state with the processor.

In the present disclosure, a “system” may include at least one of a server device and/or a cloud device, but is not limited thereto. For example, the system may be configured with one or more server devices. As another example, the system may be configured with one or more cloud devices. As yet another example, the system may be configured and operated with a server device and a cloud device.

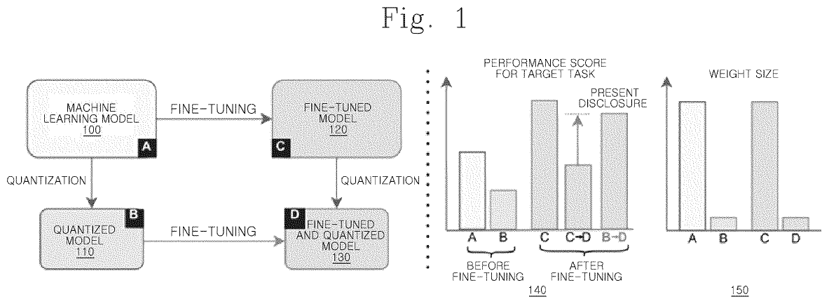

FIG. 1 illustrates an overview of a method for compressing and fine-tuning a machine learning model 100 according to some example embodiments of the present disclosure. The machine learning model 100 may be a pre-trained (or trained) machine learning model 100 that includes a large number of parameters. In some example embodiments, the machine learning model 100 may be a zero-shot or few-shot model trained through unsupervised learning or self-supervised learning method, using unlabeled training data or training data with a minimal (or lower) number of labels.

According to some example embodiments, the pre-trained (or trained) machine learning model 100 may be quantized to reduce the size of the model. For example, by quantizing at least some of the weights of the machine learning model 100, the size of the weights may be reduced. Referring to a weight size graph 150, a quantized model 110 (B), due to a reduced model size (e.g., a reduced weight size), may reduce memory requirements (or usage) for storing the model and may improve inference speed as compared to the pre-trained (or trained) machine learning model 100 (A). However, referring to a performance score graph 140 for a target task, the quantized model 110 (B) may exhibit a lower performance score than the pre-trained (or trained) machine learning model 100 (A) due to the reduced precision of the weights.

According to some example embodiments, in order to utilize the machine learning model 100 for a target task, the machine learning model 100 may be fine-tuned using training data associated with the target task. However, when all parameters of the pre-trained (or alternatively, given) machine learning model 100 are fine-tuned, excessive resources such as time and cost may be required (or otherwise, consumed) for the fine-tuning. In addition, managing checkpoints of fine-tuned models for each target task and switching between target tasks may also require (or otherwise, consume) a large amount of resources. Therefore, according to some example embodiments, instead of fine-tuning all parameters of the machine learning model 100, parameter-efficient fine-tuning may be performed by fixing some parameters of the machine learning model 100 and updating only the remaining parameters.

Referring to a performance score graph 140 for a target task, a fine-tuned model 120 (C) may be a model adapted to the target task and may exhibit better performance for the target task than the pre-trained (or trained) machine learning model 100 (A). However, referring to a weight size graph 150, since the model size of the fine-tuned model 120 (C), which is obtained only through fine-tuning, is the same as (or similar to) that of the pre-trained (or trained) machine learning model 100 (A), a larger memory space may be required (or otherwise, used) to store the model, and the inference speed may be slower.

When both model compression and fine-tuning are performed to generate a fine-tuned and quantized model 130, the advantages of the quantized model 110 and the fine-tuned model 120 may be achieved simultaneously (or contemporaneously), but this is a challenging task. As methods for generating the fine-tuned and quantized model 130, there exist two routes: a first route (A→C→D) in which quantization is performed after fine-tuning, and a second route (A→B→C) in which fine-tuning is performed after quantization.

When the fine-tuned and quantized model 130 is generated through the first route (A→C→D), fine-tuning is performed on the large machine learning model 100, resulting in a relatively large optimizer state size and a decrease in the performance score of the model during the quantization process after fine-tuning (see C→D in the performance score graph 140 for the target task).

Accordingly, the present disclosure proposes a method for generating the fine-tuned and quantized model 130 through the second route (A→B→C), in which fine-tuning is performed after quantization. The fine-tuned and quantized model 130 generated through the method of the present disclosure may exhibit excellent performance for the target task despite having a smaller model size. Accordingly, accurate inference may be performed at a higher inference speed while using a smaller memory space. In addition, according to various examples of the present disclosure, the optimizer state size may be reduced through parameter-efficient fine-tuning, and resources required (or otherwise, used) for managing and switching checkpoints for each target task may be reduced.

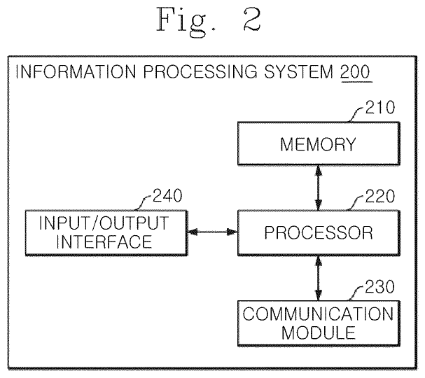

FIG. 2 is a block diagram illustrating an internal configuration of an information processing system 200 according to some example embodiments of the present disclosure. The information processing system 200 may include a memory 210, a processor 220, a communication module 230, and/or an input/output interface 240. The information processing system 200 may be configured to communicate information and/or data through a network by using the communication module 230. According to some example embodiments, operations described herein as being performed by the information processing system 200, the processor 220, the communication module 230, and/or the input/output interface 240 may be performed by processing circuitry

The memory 210 may include a non-transitory computer-readable recording medium. According to some example embodiments, the memory 210 may include a permanent mass storage device, such as a Read-Only Memory (ROM), a disk drive, a Solid-State Drive (SSD), a flash memory, or the like. As another example, a permanent mass storage device, such as a ROM, an SSD, a flash memory, or a disk drive, may be included in the information processing system 200 as a separate permanent storage device distinct from the memory. In addition, the memory 210 may store an operating system and at least one program code (e.g., a code for compressing and fine-tuning a machine learning model installed and operated on the information processing system 200).

Such software components may be loaded from a non-transitory computer-readable recording medium separate from the memory 210. The separate non-transitory computer-readable recording medium may include a recording medium directly connectable to the information processing system 200, for example, a non-transitory computer-readable recording medium, such as a floppy disk drive, a disk, a tape, a DVD/CD-ROM drive, a memory card, or the like. As another example, the software components may be loaded into the memory 210 through the communication module 230, which is not a computer-readable recording medium. For example, at least one program may be loaded into the memory 210 based on a computer program (e.g., a program for compressing and fine-tuning a machine learning model), which is installed by files provided through the communication module 230 by developers or by a file distribution system that distributes an application installation file.

The processor 220 may be configured to process instructions of a computer program by performing basic arithmetic, logic, and input/output operations. The instructions may be provided to a user terminal (not shown) or another external system by the memory 210 or the communication module 230. For example, the processor 220 may generate a quantized model by quantizing at least some of parameters of a pretrained (or trained) model, and may fine-tune the quantized model to be suitable for a target task by fixing some of the parameters of the quantized model and updating only the remaining parameters, using training data associated with the target task.

The communication module 230 may provide a configuration or function for the information processing system 200 to communicate with an external device through a network, and may provide a configuration or function for the information processing system 200 to communicate with an external system (e.g., a separate cloud system). For example, control signals, commands, data, and the like provided under the control of the processor 220 of the information processing system 200 may be transmitted to an external device and/or an external system via the communication module 230 and a network, and via a communication module of the external device and/or the external system.

In addition, the input/output interface 240 of the information processing system 200 may be a means for interfacing with a device (not shown) for input or output, the device being connected to or capable of being included in the information processing system 200. Although the input/output interface 240 is illustrated as a component separate from the processor 220 in FIG. 2, the present disclosure is not limited thereto, and the input/output interface 240 may be configured to be included in the processor 220. The information processing system 200 may include more components than those illustrated in FIG. 2. However, there is no need to clearly illustrate most conventional components.

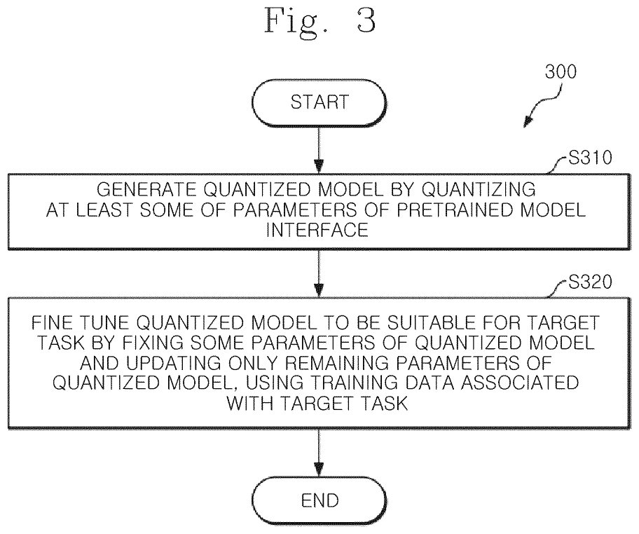

FIG. 3 is a flowchart illustrating an example of a method 300 for compressing and fine-tuning a machine learning model according to some example embodiments of the present disclosure. According to some example embodiments, the method 300 includes generating a quantized model by quantizing at least some of parameters of a pretrained (or trained) model by a processor (e.g., at least one processor of an information processing system) (S310). For example, the processor may convert at least some of parameters of a first precision included in the pretrained (or trained) model (e.g., the at least some of the parameters of the pretrained (or trained) model) into a combination of parameters of a second precision (e.g., the first subset of the parameters of the quantized model), which is lower than the first precision, and a scaling factor (e.g., the second subset of the parameters of the quantized model). In some example embodiments, at least some of the parameters of the first precision (e.g., the at least some of the parameters of the pretrained (or trained) model) that are converted into a combination of parameters of the second precision and a scaling factor may be linear transformation weights. In addition, in some example embodiments, activation (e.g., parameters of an activation layer of the pretrained (or trained) model) may not be quantized by the second precision (e.g., may not be included among the at least some of parameters of the pretrained (or trained) model).

As a specific example of converting at least some of the parameters of the first precision into a combination of the parameters of the second precision and a scaling factor, the processor may convert each of at least some of parameters of the first precision included in the pretrained (or trained) model into a combination of a predetermined (or otherwise, given) number of binary values and a scaling factor. As another specific example, the processor may convert each of at least some of parameters of the first precision included in the pretrained (or trained) model into a combination of an integer and a scaling factor. Here, the integer resulting from the conversion may be an integer within a range representable by a predetermined (or alternatively, given) number of bits.

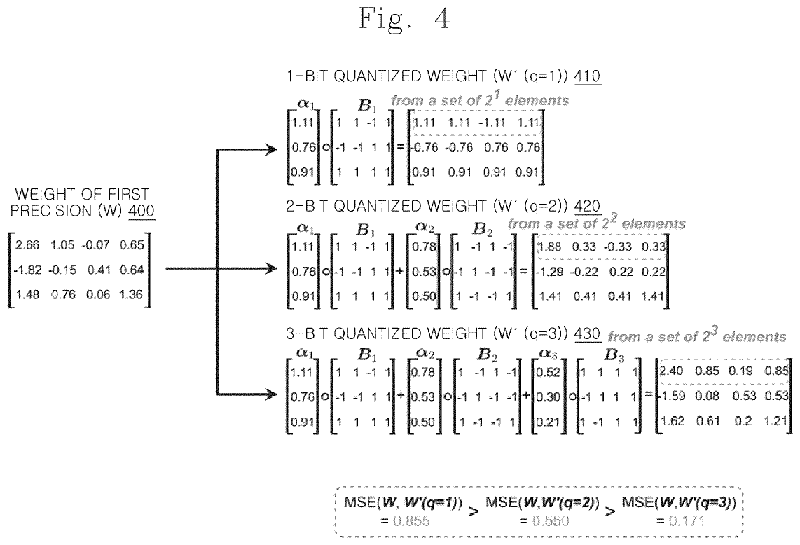

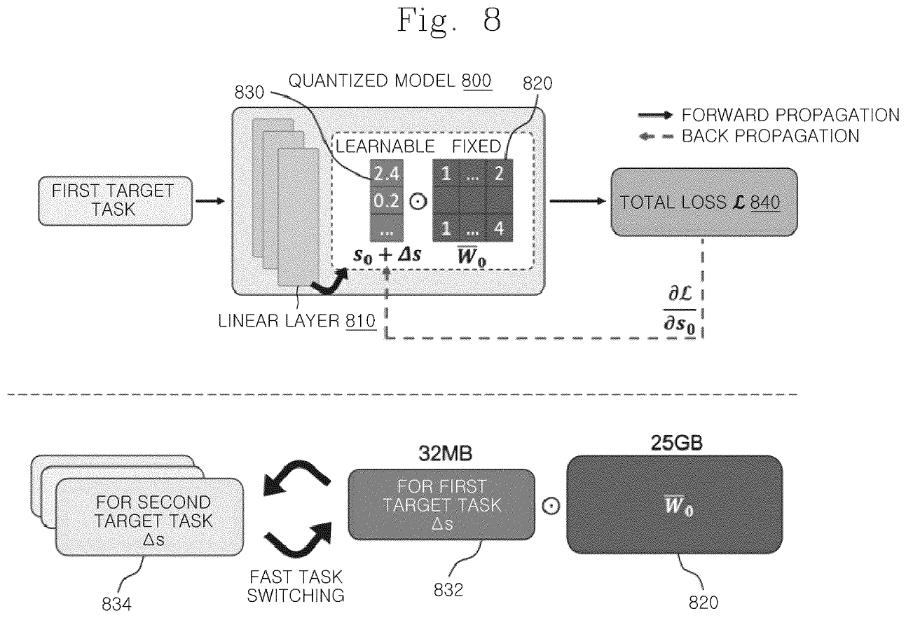

According to some example embodiments, in the quantized model, a plurality of parameters among the parameters of the second precision may share the same scaling factor (or similar scaling factors). For example, a plurality of weights belonging to the same row (or similar rows) of the same weight matrix (or similar weight matrices) among the parameters of the second precision may share the same scaling factor (or similar scaling factors). Specific examples of the method for generating the quantized model will be described in more detail below with reference to FIGS. 4 and 8.

Thereafter, the processor may fine-tune the quantized model to be suitable for a target task by fixing some of the parameters (e.g., a first subset of parameters) of the quantized model and updating only the remaining parameters (e.g., a second subset of parameters of the quantized model not include any among the first subset of parameters of the quantized model), using training data associated with the target task (S320). For example, the processor may fine-tune the quantized model by fixing the parameters of the second precision in the quantized model and updating only the scaling factor. As a specific example, the processor may fine-tune the quantized model by fixing the parameters of the second precision and updating only the scaling factors, among linear transformation weights of the first precision that have been converted into a combination of parameters of the second precision and a scaling factor in the quantized model. Here, parameters other than the scaling factors may be fixed so as not to be updated during the fine-tuning operation.

Hereinafter, specific examples of the method for compressing and fine-tuning a machine learning model according to the present disclosure will be described with reference to two representative examples. In the following description, a transformer-based language model (e.g., an Optimum Performance Training (OPT) model or a Large Language Model meta Artificial Intelligence (AI) (LLaMA) model) will be described as an example of a pre-trained (or trained) machine learning model. However, this is merely an example, and the method of the present disclosure may be applied to any machine learning model without limitation.

FIG. 4 illustrates an example of a method for quantizing at least some of parameters of a pretrained (or trained) model according to some example embodiments of the present disclosure. According to some example embodiments, an information processing system may generate a quantized model by converting at least some of parameters of a first precision included in a pretrained (or trained) model into a combination of parameters of a second precision, which is lower than the first precision, and a scaling factor. For example, the information processing system may convert linear transformation weights of a linear layer included in the pretrained (or trained) model into a combination of a predetermined (or otherwise, given) number of binary values and a scaling factor. Here, a plurality of binary values may share the same scaling factor (or have similar scaling factors). For example, a linear transformation weight vector w∈ [symbol] ^{g} of the first precision may be quantized through Equation 1 below.

$$w \approx {\sum }_{i = 1}^{q} {α}_{i} {b}_{i} \qquad [ Equation 1 ]$$

Here, q represents the number of quantization bits, α∈ [symbol] represents a scaling factor shared by q binary weights, and b∈{−1, +1}^{g} represents a binary vector. Here, the number of quantization bits (q) and the number (g) of binary weights sharing the same scaling factor (or having similar scaling factors) are hyperparameters that may be predetermined (or alternatively, given). α and b may be initialized by various methods (e.g., a least squares method (when q=1), and a heuristic method such as a greedy algorithm or an iterative fine-tuning method (when q>1)).

Similarly, a linear transformation weight matrix W∈ [symbol] ^{h}^{ₒᵤₜ}^{×h}^{ᵢₙ} of the first precision may be quantized through Equation 2 below.

$$W \approx {\sum }_{i = 1}^{q} diag ( {α}_{i} ) \cdot {B}_{i} \qquad [ Equation 2 ]$$

Here, αᵢ∈ [symbol] ^{h}^{ₒᵤₜ} and Bᵢ∈{−1, +1}^{h}^{ₒᵤₜ}^{×h}^{ᵢₙ}, and diag(·) denotes a vector function that outputs a matrix having vector elements on its diagonal and a zero matrix elsewhere. According to some example embodiments, binary weights belonging to the same row (or similar rows) of the same binary weight matrix (or similar binary weight matrices) may share the same scaling factor (or have similar scaling factors). According to some example embodiments, binary weights belonging to the same row (or similar rows) of the same binary weight matrix (B) (or similar binary weight matrices) may share the same scaling factor (or have similar scaling factors).

In FIG. 4, an example of quantizing a linear transformation weight 400 of a pretrained (or trained) model having a first precision for various numbers of quantization bits (q) is illustrated. In the illustrated example, a weight 410 quantized into 1 bit, a weight 420 quantized into 2 bits, or a weight 430 quantized into 3 bits are configured as sums of products of one, two, or three scaling factors and binary values (−1 or 1), respectively. In addition, in the illustrated example, binary values belonging to the same row (or similar rows) of the same binary weight matrix (Bᵢ) (or similar binary weight matrices) share the same scaling factor (or have similar scaling factors). In general, as the number of quantization bits (q) increases, a compression ratio and the Mean Squared Error (MSE) between the first-precision weight 400 and the quantized weights 410, 420, and 430 may decrease.

When the linear transformation weight is quantized through Equation 2, a linear transformation (Y=X·WT) may be transformed as shown in Equation 3 below.

$$\begin{matrix}Y = X \cdot {W}^{T} \\ \approx X \cdot {( {\sum }_{i = 1}^{q} diag ( {α}_{i} ) \cdot {B}_{i} )}^{T} \\ = {\sum }_{i = 1}^{q} ( ( X \cdot {B}_{i}^{T} ) \cdot diag ( {α}_{i} ) )\end{matrix} \qquad [ Equation 3 ]$$

Here, X∈ [symbol] ⁿ^{_{b}}^{×h}^{ᵢₙ} and Y∈ [symbol] ⁿ^{_{b}}^{×h}^{ₒᵤₜ}.

In most machine learning models, linear transformation weights of linear layers account for a large portion of memory requirements (or usage). Accordingly, when the linear transformation weights are quantized, the size of the model (that is, the size of the weights) may be significantly reduced. In addition, even if an input (X) of a linear transformation is not quantized, inference speed may be improved because most complex computations are eliminated (or reduced) due to binary values of a binary weight matrix. According to some example embodiments, activation may not be quantized in order to ensure (or help maintain) quantization quality.

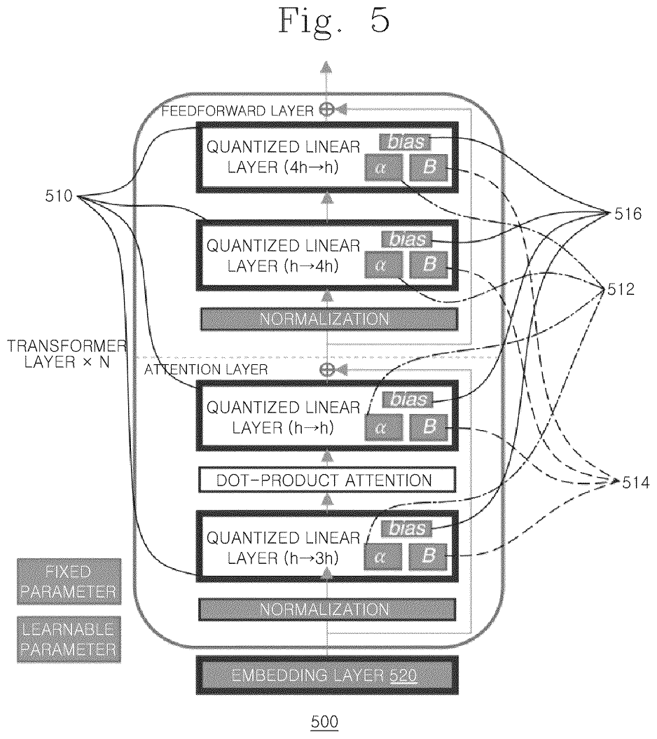

FIG. 5 illustrates an example of a structure of a quantized model 500 according to some example embodiments of the present disclosure. As an example of the structure of a quantized model 500, a quantized transformer architecture is illustrated. In the illustrated example, in the quantized transformer architecture, a quantized linear layer 510 may be a layer in which linear transformation weights included in a linear layer of an existing transformer are converted into a combination of a predetermined (or alternatively, given) number of scaling factors (α) 512 and binary weights (B) 514.

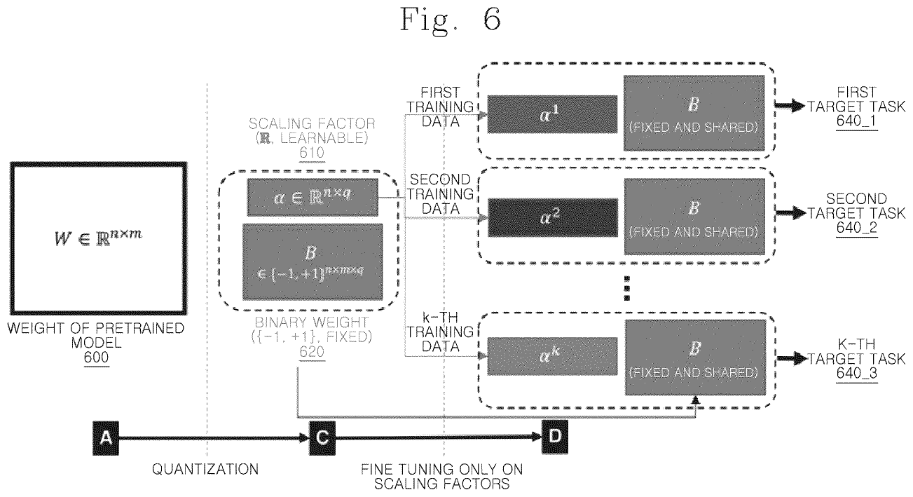

The information processing system may fine-tune the quantized model 500 by fixing some of the parameters of the quantized model 500 and updating only the remaining parameters. In the example of FIG. 5, the parameters are classified into parameters that are fixed during a fine-tuning operation and learnable parameters. For example, the information processing system may fine-tune the quantized model 500 by fixing the remaining parameters, except for scaling factors 512, of the linear layer 510 of the quantized model 500 (e.g., binary weights 514, a bias 516, and an embedding layer 520), and updating only the scaling factors 512. This will be described in more detail below with reference to FIG. 6.

FIG. 6 illustrates an example of a method for fine-tuning a quantized model according to some example embodiments of the present disclosure. As described above with reference to FIGS. 4 and 5, according to some example embodiments, an information processing system may generate a quantized model by converting at least some weights 600 of a pretrained (or trained) model into a combination of a predetermined (or alternatively, given) number of scaling factors 610 and binary weights 620.

The information processing system may fine-tune the quantized model by fixing the remaining parameters, except for the scaling factors 610, of a linear layer of the quantized model (e.g., the binary weights 620, biases, and embedding layers, and/or parameters of the same), and updating only the scaling factors 610. For example, the information processing system may fine-tune the quantized model to be suitable for the target task 640 (e.g., a first target task 640_1, a second target task 640_2, . . . , a K-th target task 640_3, collectively referred to herein as the target task 640, K being an integer having a value of 3 or greater) by updating only the scaling factors 610 of the quantized model by using training data 630 associated with a target task 640. In the quantized model, weights of linear layers account for a larger proportion, whereas scaling factors 610 account for a relatively small proportion because a plurality of binary weights 620 share the same scaling factor 610 (or have similar scaling factors 610). Accordingly, through a fine-tuning method in which binary weights 620 of linear layers that account for a larger proportion in the quantized model are fixed and only scaling factors 610 are updated, a size of parameters to be learned (for example, adjusted through training) may be significantly reduced, and thus resources required (or otherwise, used) for fine-tuning may be reduced.

In addition, when the quantized model is fine-tuned for various target tasks 640_1, 640_2, . . . 640_3 and utilized for the respective target tasks 640_1, 640_2, . . . 640_3, parameters other than the scaling factors 610, such as the binary weights 620, are fixed and shared. Therefore, only the scaling factors 610 for each of the target tasks 640_1, 640_2, . . . 640_3 need to be (or is) separately managed, thereby improving management convenience.

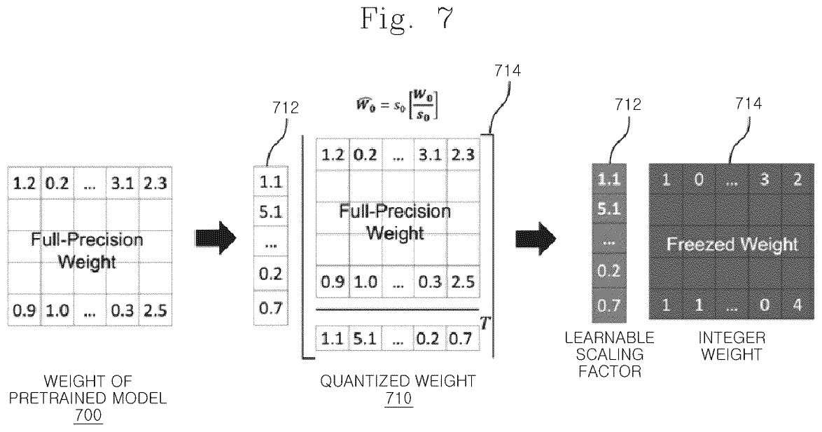

FIG. 7 illustrates an example of a method for quantizing at least some of parameters of a pretrained (or trained) model according to some example embodiments of the present disclosure. According to some example embodiments, an information processing system may convert at least some of parameters of a pretrained (or trained) model into a combination of an integer expressible with a predetermined (or alternatively, given) number of bits and a scaling factor. For example, the information processing system may convert a linear transformation weight 700 of the pretrained (or trained) model into a combination of an integer weight 714 (e.g., a quantized weight 710) and a scaling factor 712. When a linear transformation weight W₀∈ [symbol] ^{n×m} 700 of the pretrained (or trained) model is converted into a combination of the integer weight 714 and the scaling factor 712, a quantized weight [symbol] may be expressed as shown in Equation 4 below.

$$= {s}_{0} \cdot \overline{{W}_{0}} = {s}_{0} \cdot ( clamp ( ⌊ \frac{{W}_{0}}{{s}_{0}} ⌉ + {z}_{0} , 0 , {2}^{b} - 1 ) - {z}_{0} ) \qquad [ Equation 4 ]$$

Here, s₀ represents a scaling factor, W̅₀̅ represents an integer weight, b represents the number of quantization bits, └·┐ represents a rounding function, and clamp (·, a, b) represents a function that clamps an input within a range [a, b]. The number of quantization bits (b) may be a hyperparameter determined in advance, and the scaling factor (s₀) 712 and the integer weight (W̅₀̅) 714 may be initialized by various methods (e.g., a least squares method).

As described above, since linear transformation weights account for a larger portion of memory requirements (or usage), when the linear transformation weights are quantized into lower-bit integer weights and scaling factors, the model size (e.g., the weight size) may be significantly compressed. In addition, due to the quantized weights, the number of weights loaded into registers per global memory access may be increased, and thus inference speed of the quantized model may be increased.

The information processing system may fine-tune the quantized model by fixing the remaining parameters (e.g., all of the remaining parameters), except for the scaling factors 712, of linear layers of the quantized model (e.g., the integer weights 714, biases, and embedding layers), and only updating the scaling factors 712. This will be described in more detail below with reference to FIG. 8.

FIG. 8 illustrates an example of a method for fine-tuning a quantized model 800 according to some example embodiments of the present disclosure. As described above, an information processing system may fine-tune the quantized model 800 by fixing the remaining parameters, except for a scaling factor 830, of a linear layer 810 of the quantized model 800 (e.g., integer weights 820, biases, and embedding layers), and updating only the scaling factor 830. For example, the information processing system may fine-tune the quantized model 800 to be suitable for a first target task by fixing an integer weight (W̅₀̅) 820 of the quantized model 800 and updating only the scaling factor 830, using training data associated with a first target task. As a specific example, input data for training included in training data associated with the first target task may be input to the quantized model 800 to perform a forward propagation process, a total loss 840 may be calculated, and, based on the calculated total loss 840, only the scaling factor 830 may be updated through a back propagation process. Fine-tuned weights may be expressed as shown in Equation 5 below.

$$= ( {s}_{0} + Δs ) \cdot \overline{{W}_{0}} = ( {s}_{0} + Δ s ) \cdot ( clamp ( ⌊ \frac{{W}_{0}}{{S}_{0}} ⌉ + {z}_{0} , 0 , {2}^{b} - 1 ) - {z}_{0} ) \qquad [ Equation 5 ]$$

Here, Δs∈ [symbol] ^{n×1} represents a gradient update of s₀ during a fine-tuning process for a target task.

In the fine-tuning process for each target task, since the values of W̅₀̅ and s₀ are fixed, it is only necessary to separately manage (or only involves separately managing) the value of Δs in order to manage a model for each target task, thereby improving management convenience. For example, while integer weights 820 that account for a relatively large portion are fixed, a scaling factor gradient update value 832 for a first target task, which accounts for a relatively small portion, may be replaced with a scaling factor gradient update value 834 for a second target task, thereby enabling a transition from the first target task to the second target task, and allowing fast and easy task switching.

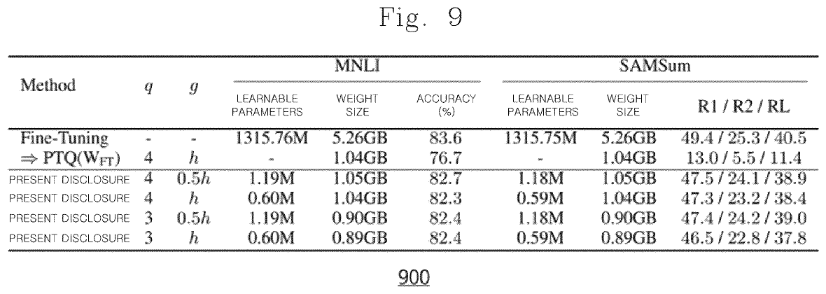

FIG. 9 illustrates an example of comparing and evaluating performance of models according to some example embodiments of the present disclosure. An illustrated performance comparison table 900 shows, for each of a model generated by a first route in which quantization is performed after fine-tuning and a model generated by a second route in which fine-tuning is performed after quantization (an example of the present disclosure), sizes of learnable parameters, weight sizes, and performance scores measured by two language model evaluation metrics (Multi-genre Natural Language Inference (MNLI) and SAMSum).

Referring to the performance comparison table 900, in the case of the model generated by the first route, it may be seen that the size of learnable parameters is larger because fine-tuning is performed on a machine learning model including a larger number of parameters before quantization. This indicates that the fine-tuning process requires (or consumes) a substantial amount of resources. In addition, it may be seen that a significant decrease in the performance score of the model occurs during the quantization process performed after fine-tuning.

On the other hand, according to the model generated by the second route (an example of the present disclosure), the size of learnable parameters may be identified as being reduced due to the parameter-efficient fine-tuning method. This indicates that resources required (or used) for the fine-tuning process may be significantly reduced. In addition, it may be seen that an excellent performance score is being maintained despite a smaller model size (a smaller weight size). Accordingly, accurate inference may be performed at a faster inference speed using a smaller memory space.

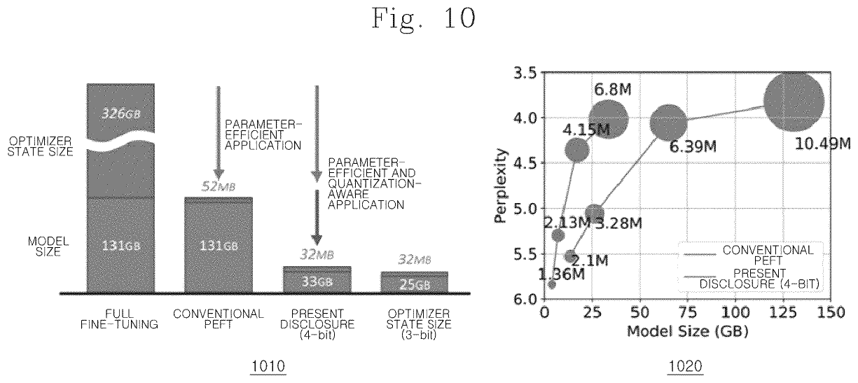

FIG. 10 illustrates an example of comparing and evaluating a model size, an optimizer size, and perplexity according to some example embodiments of the present disclosure. A first graph 1010 shows a model size and an optimizer state size for a case of full fine-tuning, a case of existing Parameter-Efficient Fine-Tuning (PEFT), and a case of fine-tuning after quantization according to some example embodiments of the present disclosure. Referring to the first graph 1010, in the case of full fine-tuning, since updates are performed for all parameters of a larger machine learning model, it may be seen that both the model size and the optimizer state size are larger. In the case of existing parameter-efficient fine-tuning, since updates are performed only for some parameters of the machine learning model, the optimizer state size is relatively reduced. However, because the model itself is not compressed, the model size remains unchanged. In the case of fine-tuning after quantization according to some example embodiments of the present disclosure, both quantization and parameter-efficient fine-tuning are performed, and thus it may be seen that both the model size and the optimizer state size are reduced.

A second graph 1020 shows perplexity with respect to model size for a case of existing parameter-efficient fine-tuning and a case of fine-tuning after quantization according to some example embodiments of the present disclosure. Perplexity is a metric commonly used to evaluate prediction performance of a language model and numerically represents how difficult it is for the model to predict new data or previously unseen data. A lower perplexity value indicates that the model better understands and predicts data. Accordingly, since a lower perplexity value indicates that the model better understands and predicts data, a lower perplexity value (e.g., a value in the +y direction in the second graph 1020) indicates superior prediction performance of the model. Referring to the second graph 1020, it may be seen that, compared to the existing parameter-efficient fine-tuning approach, the model according to the present disclosure exhibits a significantly lower perplexity value for the same model size (or similar models sizes). That is, for the same model size (or similar models sizes), the model according to the present disclosure exhibits significantly better performance than a model using existing parameter-efficient fine-tuning.

In some example embodiments, the processing circuitry may perform some operations (e.g., the operations described herein as being performed by the pre-trained (or trained) machine learning model 100, the quantized model 110, the fine-tuned model 120, the fine-tuned and quantized model 130, the quantized model 500, and/or the quantized model 800) by artificial intelligence and/or machine learning. As an example, the processing circuitry may implement an artificial neural network (e.g., the pre-trained (or trained) machine learning model 100, the quantized model 110, the fine-tuned model 120, the fine-tuned and quantized model 130, the quantized model 500, and/or the quantized model 800) that is trained on a set of training data by, for example, a supervised, unsupervised, and/or reinforcement learning model, and wherein the processing circuitry may process a feature vector to provide output based upon the training. Such artificial neural networks may utilize a variety of artificial neural network organizational and processing models, such as Convolutional Neural Networks (CNN), Recurrent Neural Networks (RNN) optionally including Long Short-Term Memory (LSTM) units and/or Gated Recurrent Units (GRU), Stacking-based Deep Neural Networks (S-DNN), State-Space Dynamic Neural Networks (S-SDNN), deconvolution networks, Deep Belief Networks (DBN), and/or Restricted Boltzmann Machines (RBM). Alternatively or additionally, the processing circuitry may include other forms of artificial intelligence and/or machine learning, such as, for example, linear and/or logistic regression, statistical clustering, Bayesian classification, decision trees, dimensionality reduction such as principal component analysis, and expert systems; and/or combinations thereof, including ensembles such as random forests.

Herein, a machine learning model (e.g., the pre-trained (or trained) machine learning model 100, the quantized model 110, the fine-tuned model 120, the fine-tuned and quantized model 130, the quantized model 500, and/or the quantized model 800) may have any structure that is trainable, e.g., with training data. For example, the machine learning model may include an artificial neural network, a decision tree, a support vector machine, a Bayesian network, a genetic algorithm, and/or the like. The machine learning model will herein be described by mainly referring to an artificial neural network, but some example embodiments are not limited thereto. Non-limiting examples of the artificial neural network may include a Convolution Neural Network (CNN), a Region based Convolution Neural Network (R-CNN), a Region Proposal Network (RPN), a Recurrent Neural Network (RNN), a Stacking-based Deep Neural Network (S-DNN), a State-Space Dynamic Neural Network (S-SDNN), a deconvolution network, a Deep Belief Network (DBN), a Restricted Boltzmann Machine (RBM), a fully convolutional network, a Long Short-Term Memory (LSTM) network, a classification network, and/or the like.

Conventional devices and methods for generating a task-specific machine learning models involve training a language model, and subsequently further training the trained language model for a specific task to which the resulting model will be applied. However, this further training (e.g., fine-tuning) performed with respect to the trained model involves adjusting a large number of parameters of the model, resulting in excessive resource consumption (e.g., memory, processor, delay, power, etc.).

However, according to some example embodiments, improved devices and methods are provided for generating a task-specific machine learning model. For example, the improved devices and methods may involve quantizing a trained model to reduce a size of the model prior to further training (e.g., fine-tuning) the model for a specific task to which the resulting model will be applied. Due to the smaller model size, the further training may be performed using fewer resources (e.g., memory, processor, delay, power, etc.) and the resulting model may be capable of performing inferences at higher speeds. Therefore, the improved devices and methods overcome the deficiencies of the conventional devices and methods to at least reduce resource consumption and/or increase inference speed.

The method described above may be provided in the form of a computer program stored on a non-transitory computer-readable recording medium for execution by a computer. The medium may continuously store a computer-executable program, or may temporarily store the program for execution or downloading. In addition, the medium may be various recording means or storage means in the form of a single hardware component or a combination of multiple hardware components, and is not limited to a medium directly connected to a computer system, but may be distributed over a network. Examples of the medium include magnetic media such as a hard disk, a floppy disk, and a magnetic tape, optical recording media such as a CD-ROM and a DVD, magneto-optical media such as a floptical disk, and media configured to store program instructions, such as a ROM, a RAM, a flash memory, and the like. In addition, as another example of the medium, a recording medium or a storage medium managed by an application store that distributes applications, or by a site or server that supplies or distributes various software, may also be included.

The methods, operations, or techniques of the present disclosure may be implemented by various means. For example, such techniques may be implemented in hardware, firmware, software, or a combination thereof. Those skilled in the art will understand that the various example logical blocks, modules, circuits, and algorithm operations described herein in connection with the present disclosure may be implemented in electronic hardware, computer software, or a combination thereof. In order to clearly explain the interchangeability of hardware and software, various example components, blocks, modules, circuits, and operations have been described above generally in terms of their functions. Whether such functions are implemented as hardware or software depends on a particular application and design requirements (or configurations) imposed on an overall system. Those skilled in the art may implement the described functions in various ways for each particular application. However, such implementations should not be construed as departing from the scope of the present disclosure.

In a hardware implementation, processing units used to perform the techniques may be implemented by one or more ASICs, DSPs, Digital Signal Processing Devices (DSPDs), Programmable Logic Devices (PLDs), Field Programmable Gate Arrays (FPGAs), processors, controllers, microcontrollers, microprocessors, electronic devices, other electronic units designed to perform the functions described herein, computers, or any combination thereof.

Accordingly, the various example logical blocks, modules, and circuits described in conjunction with the present disclosure may be implemented or performed by a general-purpose processor, a DSP, an ASIC, an FPGA, or other programmable logic device, discrete gate or transistor logic, discrete hardware components, or any combination thereof designed to perform the functions described herein. The general-purpose processor may be a microprocessor. Alternatively, the processor may be any processor, controller, microcontroller, or state machine. The processor may also be implemented as a combination of computing devices, for example, a combination of a DSP and a microprocessor, a plurality of microprocessors, one or more microprocessors in conjunction with a DSP core, or any other combination of such configurations.

In firmware and/or software implementations, the techniques may be implemented as instructions stored on a non-transitory computer-readable medium, such as a Random Access Memory (RAM), a Read-Only Memory (ROM), a Non-Volatile Random Access Memory (NVRAM), a Programmable Read-Only Memory (PROM), an Erasable Programmable Read-Only Memory (EPROM), an Electrically Erasable PROM (EEPROM), a flash memory, a compact disc (CD), or a magnetic or optical data storage device. The instructions may be executable by one or more processors and may cause the processor(s) to perform specific aspects of the functions described in the present disclosure.

When implemented in software, the techniques may be stored on or transmitted through a computer-readable medium as one or more instructions or codes. The computer-readable media include both computer storage media and communication media, and include any medium that facilitates transmission of a computer program from one location to another. The storage media may be any available media accessible by a computer. As a non-limiting example, such non-transitory computer-readable media may include RAM, ROM, EEPROM, CD-ROM or other optical disk storage, magnetic disk storage or other magnetic storage devices, or any other medium that may be used to transport or store desired program code in the form of instructions or data structures and that may be accessed by a computer. In addition, any connection is appropriately referred to as a computer-readable medium.

For example, when software is transmitted from a website, a server, or another remote source using coaxial cables, fiber optic cables, twisted pair cables, Digital Subscriber Lines (DSL), or wireless technologies such as infrared, radio, or microwave, such coaxial cables, fiber optic cables, twisted pair cables, DSL, or wireless technologies are included within the definition of a medium. As used herein, the terms “disk” and “disc” include a CD, a laser disc, an optical disc, a Digital Versatile Disc (DVD), a floppy disc, and a Blu-ray disc, wherein disks usually reproduce data magnetically, whereas discs usually reproduce data optically using a laser. The above combinations should also be included within the scope of computer-readable media.

A software module may reside in a RAM memory, a flash memory, a ROM memory, an EPROM memory, an EEPROM memory, registers, a hard disk, a removable disk, a CD-ROM, or any other type of storage medium known in the art. An example storage medium may be connected to a processor such that the processor may read information from or write information to the storage medium. Alternatively, the storage medium may be integrated with the processor. The processor and the storage medium may reside within an ASIC. The ASIC may reside within a user device. Alternatively, the processor and the storage medium may exist as separate components within the user device.

Although the examples described above have been described as utilizing aspects of the present disclosure in one or more standalone computer systems, the present disclosure is not limited thereto and may be implemented in conjunction with any computing environment, such as a network or a distributed computing environment. Furthermore, aspects of the present disclosure may be implemented in multiple processing chips or devices, and storage may similarly be implemented across multiple devices. Such devices may include personal computers, network servers, and portable devices.

Although the present disclosure has been described in connection with some example embodiments, it should be understood that various modifications and changes may be made by those skilled in the art without departing from the scope of the present disclosure. In addition, such modifications and changes should be considered as falling within the scope of the appended claims.

1. A method, performed by at least one processor, for compressing and fine-tuning a machine learning model, the method comprising:
generating a quantized model by quantizing at least some of parameters of a trained machine learning model; and
fine-tuning the quantized model for a target task by,
fixing a first subset of parameters of the quantized model, and
updating only a second subset of the parameters of the quantized model using training data associated with the target task, the second subset of the parameters of the quantized model not including any parameter among the first subset of parameters of the quantized model.

2. The method of claim 1, wherein
the at least some of the parameters of the trained machine learning model are of a first precision; and
the generating the quantized model includes converting the at least some of the parameters of the trained machine learning model into,
parameters of a second precision, the second precision being lower than the first precision, and
a scaling factor.

3. The method of claim 2, wherein
the first subset of the parameters of the quantized model include the parameters of the second precision; and
the second subset of the parameters of the quantized model include the scaling factor.

4. The method of claim 2, wherein the at least some of the parameters of the trained machine learning model include linear transformation weights.

5. The method of claim 2, wherein a plurality of parameters among the parameters of the second precision share a same scaling factor, the plurality of parameters being parameters of the quantized model.

6. The method of claim 5, wherein a plurality of weights belonging to a same row of a same weight matrix among the parameters of the second precision share a same scaling factor.

7. The method of claim 2, wherein the converting includes converting each of the at least some of the parameters of the trained machine learning model into a number of binary values and the scaling factor.

8. The method of claim 2, wherein the converting includes converting each of the at least some of the parameters of the trained machine learning model into an integer and the scaling factor, the integer being within a range of values representable by a number of bits.

9. The method of claim 2, wherein the at least some of parameters of the trained machine learning model do not include parameters of an activation layer of the trained machine learning model.

10. The method of claim 1, wherein the first subset of parameters of the quantized model includes parameters of biases and embedding layers of the quantized model.

11. A non-transitory computer-readable recording medium recording instructions that, when executed by a computer, cause the computer to perform the method according to claim 1.

12. An information processing system comprising:
a memory including at least one computer-readable program; and
at least one processor connected to the memory and configured to execute the at least one computer-readable program to cause the information processing system to,
generate a quantized model by quantizing at least some of parameters of a trained machine learning model, and
fine-tune the quantized model for a target task by,
fixing a first subset of the parameters of the quantized model, and
updating only a second subset of the parameters of the quantized model using training data associated with the target task, the second subset of the parameters of the quantized model not including any parameter among the first subset of parameters of the quantized model.

13. The information processing system of claim 12, wherein
the at least some of the parameters of the trained machine learning model are of a first precision; and
the information processing system is further caused to perform the generating the quantized model including converting the at least some of the parameters of the trained machine learning model into,
parameters of a second precision, the second precision being lower than the first precision, and
a scaling factor.

14. The information processing system of claim 13, wherein
the first subset of the parameters of the quantized model include the parameters of the second precision; and
the second subset of the parameters of the quantized model include the scaling factor.

15. The information processing system of claim 13, wherein the at least some of the parameters of the trained machine learning model include linear transformation weights.

16. The information processing system of claim 13, wherein a plurality of parameters among the parameters of the second precision share a same scaling factor, the plurality of parameters being parameters of the quantized model.

17. The information processing system of claim 16, wherein a plurality of weights belonging to a same row of a same weight matrix among the parameters of the second precision share a same scaling factor.

18. The information processing system of claim 13, wherein the information processing system is further caused to perform the converting including converting each of the at least some of the parameters of the trained machine learning model into a number of binary values and the scaling factor.

19. The information processing system of claim 13, wherein the information processing system is further caused to perform the converting including converting each of the at least some of the parameters of the trained machine learning model into an integer and the scaling factor, the integer being within a range of values representable by a number of bits.

20. The information processing system of claim 13, wherein the at least some of parameters of the trained machine learning model do not include parameters of an activation layer of the trained machine learning model.
